(19) United States
(12) Patent Application Publication
(10) Pub. No.: US 2018/0076845 A1
(43) Pub. Date: Mar. 15, 2018

(54) Phone Case with Holder for Replaceable Personal Item

(71) Applicant: Not Just Another Pretty Face LLC, New York, NY (US)

(72) Inventor: Madeline McCabe, Marina Del Ray, CA (US)

(73) Assignee: Not Just Another Pretty Face LLC, New York, NY (US)

(21) Appl. No.: 15/265,577

(22) Filed: Sep. 14, 2016

(51) Int. Cl. H04B 1/3888; A45D 29/04

(52) U.S. Cl. CPC H04B 1/3888; A45D 29/04

(57) ABSTRACT

A case for a cellular telephone. The telephone case has an outer casing designed to protect a cellular phone, with features to secure the telephone case to the phone and features to protect the phone from one or more hazards. The telephone case has features designed to securely and replaceably retain a mass-market nail file affixed to the phone with sufficient rigidity to permit use of the file anchored to the phone, with its rough surface presented to a user.

### BACKGROUND

This application relates to protective cases for cellular telephones.

### SUMMARY

In general, in a first aspect, the invention features a case for a cellular telephone. The telephone case has an outer casing designed to protect a cellular phone, with features to secure the telephone case to the phone and features to protect the phone from one or more hazards. The case has features designed to securely and replaceably retain a mass-market nail file affixed to the phone with sufficient rigidity to permit use of the file anchored to the phone, with its rough surface presented to a user.

Embodiments of the invention may include one or more of the following features. The retaining features may be resilient structures designed to retain the nail file in place with its rough surface presented through the opening. The resilient retaining features for the nail file may be formed of the same plastic as resilient features used to secure the telephone case to the phone. The telephone case may further incorporate a metal, glass, plastic, foam, or paper backing between the phone and the nail file, to protect the phone from abrasion. The telephone case may have features designed to adapt the telephone case to securely and replaceably retain nail files of varying configuration. The features to adapt may include a set of interchangeable parts, each part in the set designed to securely and replaceably retain nail files of a specific configuration. The telephone case may have features to permit interchangeable decorative panels.

The above advantages and features are of representative embodiments only, and are presented only to assist in understanding the invention. It should be understood that they are not to be considered limitations on the invention as defined by the claims. Additional features and advantages of embodiments of the invention will become apparent in the following description, from the drawings, and from the claims.

### DESCRIPTION OF THE DRAWINGS

FIG. 1 is a perspective exploded drawing of a cellular phone and a phone case.

FIGS. 2, 3 and 5 are section views of a telephone case.

FIG. 4 is an exploded perspective view of a telephone case, partially cut away.

### DESCRIPTION

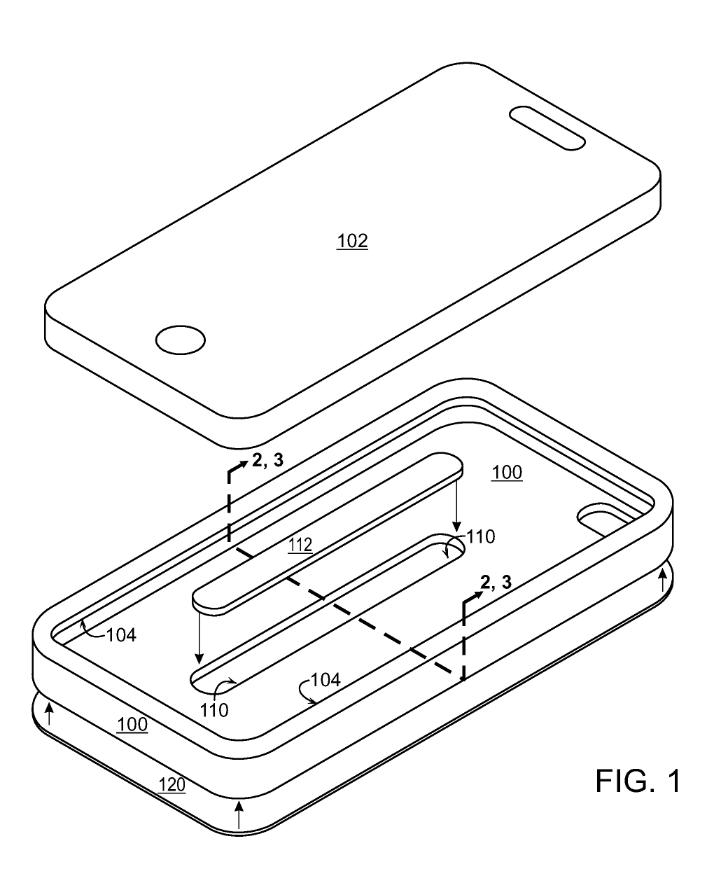

Referring to FIG. 1, a telephone case 100 is designed to hold a cellular phone to protect it. At the back of the telephone case may be an oval opening 110 the size and shape of a nail file 112. The edge of opening 110 may be arranged to hold nail file 112 securely for use, and to allow for easy disposal and replacement of nail file 112 as the nail file wears out through use.

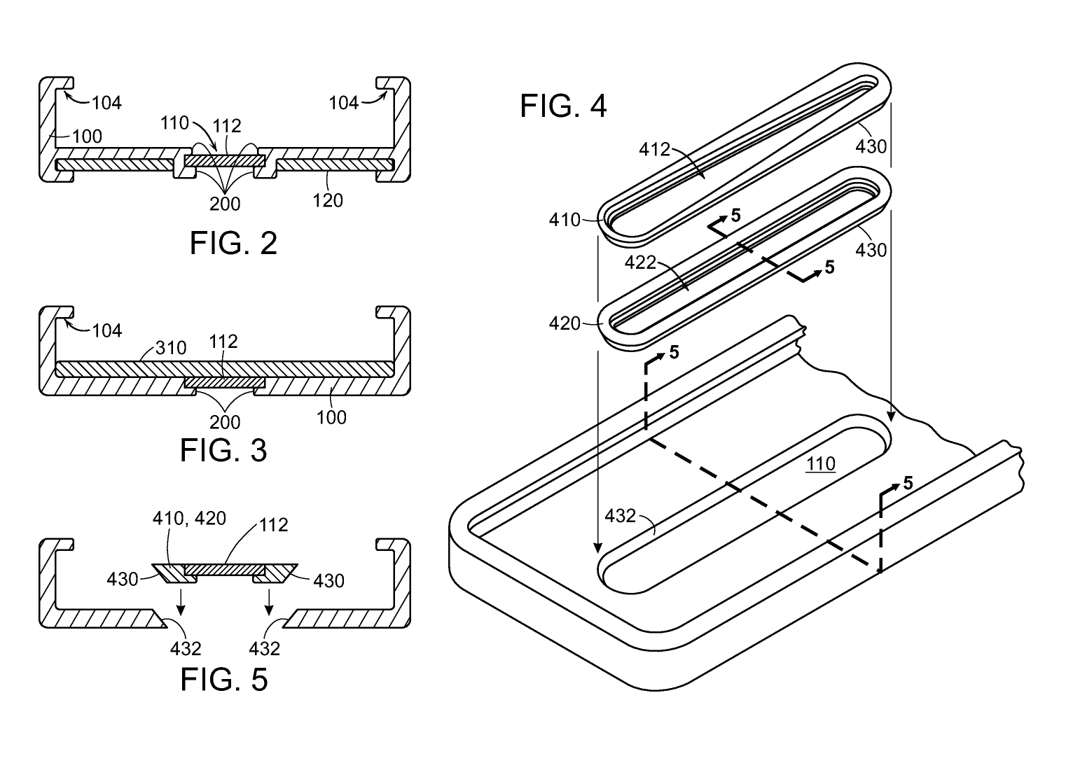

Referring to FIG. 2, opening 110 may have features 200 that grip nail file 112. The same resiliency of case materials used to hold the telephone case about the phone may be used in gripping features 200 to hold nail file 112 as well Opening 110 and gripping features 200 may be shaped to retain a common nail file 112 as nail files are commonly sold to consumers. Types of nail file may include emery boards and others. Because various brands of nail file 112 are of a few uniform sizes, opening 110 and features 200 that hold nail files 112 of one of the common shapes of off-the-shelf nail files may be preferred. Opening 110 may be arranged longitudinally or diagonally across the back of case 100 to allow for the full length of off-the-shelf nail files.

Referring to FIG. 3, case 100 may be designed so that nail file 112 may be inserted and removed from the back of the telephone case 100. That is, to replace nail file 112, phone 102 may be removed from case 100 to expose the inner surface of case 100. Recess 110, 200 holding nail file 112 may be wider on the inside facing phone 102, than outside, and nail file 112 may be retained between the back of the phone and the smaller opening facing the outside.

In some cases, a metal, glass, plastic, foam, or paper backing 310 may be included between the phone and nail file 112, to protect the phone from abrasion.

Referring to FIGS. 4 and 5, nail files come in several common shapes. For example, some nail files have two parallel edges, while others have these two edges non-parallel. The telephone case may be sold with two or more inserts 410, 420 that each grip a nail file 112 of a specific shape, and each insert may have the same outer shape. This outer shape may in turn engage with retaining features of the telephone case itself. For example, insert 410 may have a recess 412 with non-parallel edges to fit more trapezoidal files, and insert 420 may have a recess 422 with parallel sides. Inserts 410, 420 may have edge features that engage with the edge of opening 110, such as beveled edges 430 that engage with beveled edge 432

Nail file 112 may be held in place by a snap, pincers, a lever that tightens, or other mechanical features to hold nail file 112 in place. These arrangements may be especially preferable when the telephone case is constructed to rigid material, for example, aluminum.

Phone case 100 with features to removably hold a nail file may permit a person to carry nail file 112 routinely, to file or otherwise clean up nails, or to polish away any skin chafing, broken nail, or other roughness that needs to be filed. By having a nail file 112 connected to phone 102, a user may have a nail file constantly available to file his or her nails on the go, without the morning ritual or remembering to carry one. Finding a nail file is easier if it is attached to a user's phone 102, rather than lost in the bottom of a pocketbook or handbag. Because most people keep their cell phones nearby, a nail file 112 will always be handy and near by as well. A case that permits easy replacement of nail file 112 allows a fresh nail file 112 to be inserted and kept handy.

Returning to FIG. 1, case 100 may be sized to fit a specific model of phone, and sold in different models to fit different models of phone. Case 100 may be made of plastic, rubber, leather, or other material, or a combination of materials selected for impact resistance, water resistance, crush resistance, or protection against any other hazard, and resilient features or other features to hold the phone and nail file 112. Case 100 may be constructed as a tray with features that engage a telephone 102 in the tray. For example, case 100 may have a resilient lip 104 that wraps just far enough around the front of the telephone 102 to hold the phone. Case 100 may be constructed of impact-absorbing material to protect against dropping or other blows, while still allowing full visibility of the front glass screen of the phone.

Case 100 may have features on the back that grip replaceable colored inserts 120. Inserts 120 may be sold in sets of varying colors.

For the convenience of the reader, the above description has focused on a representative sample of all possible embodiments, a sample that teaches the principles of the invention and conveys the best mode contemplated for carrying it out. Throughout this application and its associated file history, when the term “invention” is used, it refers to the entire collection of ideas and principles described; in contrast, the formal definition of the exclusive protected property right is set forth in the claims, which exclusively control. The description has not attempted to exhaustively enumerate all possible variations. Other undescribed variations or modifications may be possible. Where multiple alternative embodiments are described, in many cases it will be possible to combine elements of different embodiments, or to combine elements of the embodiments described here with other modifications or variations that are not expressly described. A list of items does not imply that any or all of the items are mutually exclusive, nor that any or all of the items are comprehensive of any category, unless expressly specified otherwise. In many cases, one feature or group of features may be used separately from the entire apparatus or methods described. Many of those undescribed variations, modifications and variations are within the literal scope of the following claims, and others are equivalent.

1. A telephone case, comprising:
a case designed to protect a cellular phone, with features to secure the telephone case to the phone and features to protect the phone from one or more hazards;
the telephone case having features designed to securely and replaceably retain a mass-market nail file affixed to the phone with sufficient rigidity to permit use of the file anchored to the phone, with its rough surface presented to a user.

2. The telephone case of claim 1, wherein:
the retaining features are resilient structures designed to retain the nail file in place with its rough surface presented through the opening.

3. The telephone case of claim 2, wherein:
the resilient retaining features for the nail file are formed of the same plastic as resilient features used to secure the telephone case to the phone.

4. The telephone case of claim 1, further comprising:
a metal, glass, plastic, foam, or paper backing between the phone and the nail file, to protect the phone from abrasion.

5. The telephone case of claim 1, further comprising:
features designed to adapt the telephone case to securely and replaceably retain nail files of varying configuration.

6. The telephone case of claim 5, further comprising:
the features to adapt include a set of interchangeable parts, each part in the set designed to securely and replaceably retain nail files of a specific configuration.

7. The telephone case of claim 1, further comprising:
features to permit interchangeable decorative panels.

8. A method, comprising the steps of:
by hands and without use of an adhesive, inserting into features of a telephone case a disposable, replaceable, mass-market nail file, the features designed to securely and replaceably retain the mass-market nail file affixed to a cellular phone also held in the telephone case, the telephone case and features holding the nail file with sufficient rigidity to permit use of the file anchored to the phone, with a rough surface of the nail file presented to a user in a conformation to securely hold the file in position to file the user's nails;
the telephone case designed to protect a cellular phone, with features to secure the telephone case to the phone and features to protect the phone from one or more hazards.

9. The method of claim 8, wherein:
the retaining features are resilient structures designed to retain the nail file in place with its rough surface presented through the opening.

10. The method of claim 9, wherein:
the resilient retaining features for the nail file are formed of the same plastic as resilient features used to secure the telephone case to the phone.

11. The method of claim 8, further comprising:
inserting into the telephone case a metal, glass, plastic, foam, or paper backing between the phone and the nail file, to protect the phone from abrasion.

12. The method of claim 8, wherein:
the telephone case has features designed to adapt the telephone case to securely and replaceably retain nail files of varying configuration.

13. The method of claim 12, wherein:
the features to adapt include a set of interchangeable parts, each part in the set designed to securely and replaceably retain nail files of a specific configuration.

14. The method of claim 8, wherein:
the telephone case has features to permit interchangeable decorative panels.

15. A telephone case, comprising:
a case designed to protect a cellular phone, with features to secure the telephone case to the phone and features to protect the phone from one or more hazards;
the telephone case having features designed to securely and replaceably retain a disposable, replaceable, mass-market nail file affixed to the phone with sufficient rigidity to permit use of the file anchored to the phone, with its rough surface presented to a user in a conformation to securely hold the file in position to file the user's nails.

16. The telephone case of claim 15, wherein:
the retaining features are resilient structures designed to retain the nail file in place with its rough surface presented through the opening.

17. The telephone case of claim 16, wherein:
the resilient retaining features for the nail file are formed of the same plastic as resilient features used to secure the telephone case to the phone.

18. The telephone case of claim 15, further comprising:
a metal, glass, plastic, foam, or paper backing between the phone and the nail file, to protect the phone from abrasion.

19. The telephone case of claim 15, further comprising:
features designed to adapt the telephone case to securely and replaceably retain nail files of varying configuration.

20. The telephone case of claim 19, further comprising:
the features to adapt include a set of interchangeable parts, each part in the set designed to securely and replaceably retain nail files of a specific configuration.
